(19) United States
(12) Patent Application Publication
(10) Pub. No.: US 2021/0177027 A1
(43) Pub. Date: Jun. 17, 2021

(54) PROCESS FOR REPLACING EGG IN PASTA

(71) Applicant: Harvest Innovations, Indianola, IA (US)

(72) Inventors: Noel Rudie, Oskaloosa, IA (US); Giovanni Santi, Northbrook, IL (US)

(21) Appl. No.: 17/188,732

(22) Filed: Mar. 1, 2021

Related U.S. Application Data
(63) Continuation of application No. 14/052,053, filed on Oct. 11, 2013.
(60) Provisional application No. 61/712,525, filed on Oct. 11, 2012.

(51) Int. Cl. A23L 29/206; A23L 29/231; A23L 29/269; A23L 7/109; A23L 15/00

(52) U.S. Cl. CPC A23L 29/206; A23L 29/231; A23V 2002/00; A23L 7/109; A23L 15/35; A23L 29/27

(57) ABSTRACT

The various embodiments disclosed herein relate to methods and compositions for use as eggless pasta additive, including some that also enhance the texture, shelf life, and safety of the pasta. The various compositions can include a hydrocolloid, a salt, and a fiber. In certain embodiments, the additive further comprises a protein. In various embodiments, the hydrocolloid can be a gum or a stare.

### CROSS-REFERENCE TO RELATED APPLICATIONS

This application is a continuation of U.S. patent application Ser. No. 14/052,053, tiled Oct. 11, 2013, which itself claims priority from U.S. Provisional Application 61/712,525, filed Oct. 11, 2012, and entitled “Egg Substitute,” each of the contents of the entirety of which are hereby incorporated herein by reference.

### TECHNICAL FIELD

This invention relates to a composition useful in the preparation of foods. More specifically, the present invention relates to a stabilizer and fortifier capable of replacing egg or egg whites in pasta formulations.

### BACKGROUND

Pasta manufacturers have been looking for a replacement for eggs in their formulations with years, with little success. Food manufacturers have long attempted to both reduce the costs of producing pastas and other foods, such as bakery, breadings and meat hinders to eliminate the use of eggs in their formulations due to health and allergen concerns. There is thus a need in the art for a cost-effective and egg-free additive for use in the production of pastas and other foods.

### BRIEF SUMMARY OF THE INVENTION

The present disclosure relates to a composition and method for providing a pasta fortifier and stabilizer comprising a mixture of hydrocolloids, fibers, salts and optionally proteins. Certain embodiments relate to the method of mixing the composition with flour and water to produce pasta. This composition and method can he used to create egg-free pasta Which delivers the texture, bite and chew of pastas made with whole egg or egg white, and can be used in fresh, frozen, or dried pastas.

The embodiments disclosed herein thus can serve as a vegan or vegetarian substitute for eggs or egg whites in pastas and other related foods. These embodiments can also eliminate certain microbiological concerns, particularly the risk of salmonella associated with eggs and egg whites. These embodiments are also easier to handle than liquid eggs and may have better shelf stability than dried eggs. Finally, the composition and method of manufacture can replace all of the egg or egg white rather than being, used as a partial substitution.

To that end, it is an object of the present invention to provide a fortifier or stabilizer that replaces egg or egg whites in pasta formulations.

It is a further object of the present invention to provide a pasta fortifier or stabilizer comprising hydrocolloids, fibers and salts.

Another object of the present invention is to provide a pasta fortifier or stabilizer providing the same or similar bite and chew of pastas made with whole egg or egg white.

Yet an additional object of the present invention is to provide a pasta fortifier or stabilizer that improves the texture and chew in dried, fresh or frozen pasta.

### BRIEF DESCRIPTION OF THE DRAWINGS

FIG. 1 shows a table of the compositions of such embodiments of the additive,

FIG. 2 shows a table showing the texture amilysis of various embodiments of the additive mixed with Semolina Durum Flour.

FIG. 3 shows a table showing the texture analysis of various embodiments of the additive mixed with Extra Fancy Flour.

FIG. 4 shows a table showing the texture analysis of various embodiments of the additive mixed with 50% Semolina Durum Flour and 50% Extra Fancy Flour.

FIG. 5 shows a. table showing the texture analysis of one embodiment of the additive mixed with Red Lentil Flour.

FIG. 6 shows a table showing the texture analysis of certain exemplary embodiments of the additive with retort canned pasta.

### DETAILED DESCRIPTION OF THE INVENTION

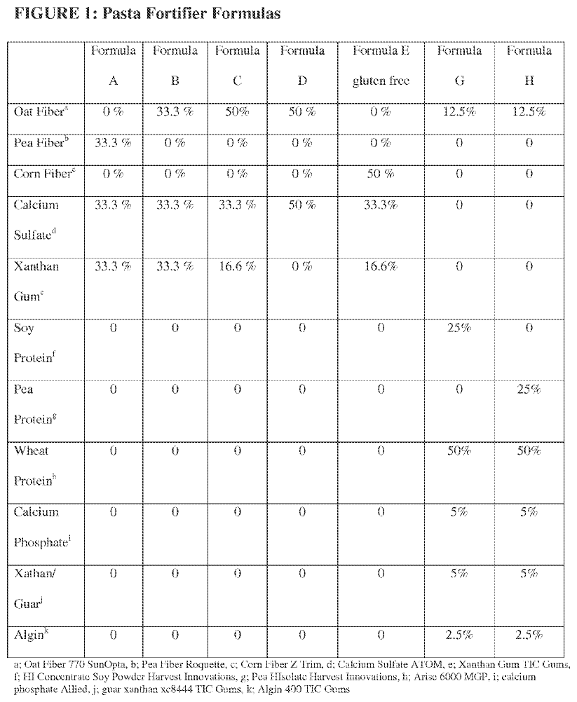

The present invention relates to formulations for use in the production of pastas and other foods. As seen in FIGS. 1-6 exemplary embodiments of the present invention are a fortifier, comprising at least one hydrocolloid, at least one fiber, and at least one salt as a substitute for eggs, and mixed with flour and water in the formulation of pasta. In certain embodiments, protein is also included in the composition. It was unexpected and surprising that the fortifier does not actually require the presence of a protein to replace the albumin in egg.

In various embodiments, the composition is mixed in to a total ratio of about 2.5% weightivolume with flour and water to produce pasta. As would be apparent to one of skill in the art, a range of values is appropriate in various embodiments, based upon the constituent components of the formulation and the desired texture and character of the pasta.

In certain exemplary embodiments, the fortifier includes a hydrocolloid, such as a starch or starches, such as corn starch, pea starch, potato starch, rice starch, wheat starch, and pea extract. In further exemplary embodiments, the hydrocolloid may be a gum or combination of gums such as xanthan, guar, locust bean, gum Arabic, tarn gum, algin, carboxymethyl cellulose, carrageenan or pectin. Certain embodiments further comprise a fiber such as oat fiber, soy fiber, pea fiber, corn fiber. carrot fiber, citrus fiber, potato fiber, rice fiber or orange fiber. Further, certain exemplary embodiments comprise a salt such as organic or inorganic calcium, magnesium, sodium or potassium salts such as calcium sulfate, calcium phosphate, calcium chloride, calcium carbonate, calcium citrate, calcium lactate,, calcium propionate, calcium oleate, magnesium sulfate, magnesium phosphate, magnesium acetate, magnesium chloride, magnesium citrate or magnesium lactate, in certain embodiments a protein may also be used, though it is not necessary. These protein-containing embodiments may comprise proteins such as pea protein, soy protein or wheat protein.

As would also be apparent to one of skill in the art, certain compositions can contain ingredients, such as pea extract, which contain multiple components of the composition. For example, pea extract contains both fiber and starch. One of skill in the art will readily recognize that there may be other hydrocolloids. fibers, salts and proteins are within the scope of this invention, and that certain organic ingredients can provide more than one of these components, The invention is not limited to those listed herein.

As described herein in relation to the figures, the relative proportions of each of the constituent parts may vary, based upon the individual characteristics of each of the parts and the desired effect on the pasta. In certain exemplary embodiments, approximately equal quantities of the hydrocolloid, salt, and fiber can be added. in certain other embodiments, one component can account for 50%, 60%, or more of the additive composition, while another component may be almost 0%. By way of example, when using a component such as pea extract, the relative proportions of other fiber and hydrocolloid may be adjusted.

The hydrocolloids in the present invention improve cohesiveness and add elasticity, while the sails cross-link proteins in the pasta giving it bite, strength and stability. The fiber contributes strength and water binding. The optional proteins can be utilized to add cohesiveness and elasticity. One feature of the salts is to strengthen the product by cross linking proteins, either optional or inherent m other components.

As shown in FIGS. 1-5, various formulations were assayed for specific mouthfeel and texture characteristics as a means of con the present invention with typical commercially-available pastas and gluten-free varieties. As one of skill in the art would clearly recognize, many other embodiments and formulations are possible and are discussed elsewhere herein,

The various assayed pastas, including certain embodiments of the present invention and controls were cooked in boiling water to al dente drained, rinsed. sampled and scored for firmness, elasticity and stickiness,pasta texture analysis was performed organoleptically by a trained panel. Firmness, elasticity, and stickiness characteristics were scored on a 10-point hedonic scale with 10 being high and 1 being low. As used here, “firmness” represents the degree of resistance to the first bite or the force required to penetrate the pasta with teeth. Very firm is 10 and not firm is 1 on the hedonic scale. “Elasticity” represents the capacity of pasta to return to its initial condition when the deforming force is removed. Very elastic is scored a 10 and not elastic is scored a 1 on the hedonic scale. “Stickiness” or “starchiness” is the force with which the cooked pasta surface adheres to other materials, e.g., tongue, teeth, palate, fingers, pasta. Stickiness was further evaluated as the pasta. cooled. “Not sticky” is 10 and “very sticky” is 1 on the hedonic scale. As is well known in the art, the best pasta is firm, elastic and not sticky.

As shown in FIG. 1, various pastas containing exemplary embodiments of the fortifier (hereinafter also referred to as “EggOut”) (Formula A-formula (ii) were tested . In these embodiments, the formulations comprise the quantities of Oat Fiber 770 SunOpta, Pea Fiber Roquette, Corn Fiber Z Trim, Calcium Sulfate ATOM, Xanthan Gum Tr Gums, soy protein Harvest Innovations, pea protein Harvest Innovations and wheat protein MGP specified in FIG. 1. As is also shown in FIG. 1, Formula E was gluten free. As one of skill in the art would readily recognize, this list is by no means exhaustive and other compositions are possible. For example, formulations comprising oat fiber, calcium sulfate, pea extract, and xanthan gum have also been utilized, as well as formulations comprising oat fiber, calcium sulfate, pea starch, pea fiber, and xanthan gum. By way of example, in certain embodiments used in frozen or restaurant preparations, for example, about 50% oat fiber, about 33% calcium sulfate, and about 16.7% xanthan gum may be used. In certain retort embodiments, about 22.2% calcium sulfate, about 16.7% xanthan gum, about 27.8% oat fiber, and about 33.3% pea extract can be used. As would be apparent to one of skill in the art, many other embodiments are possible.

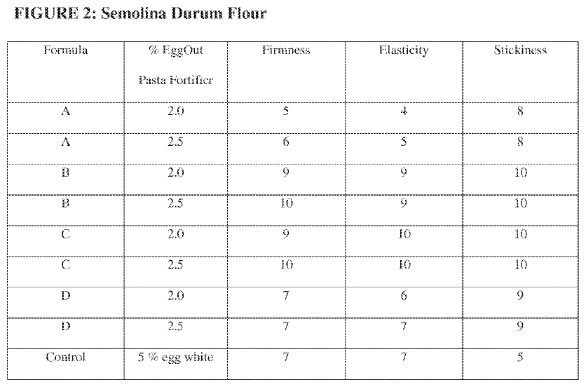

As is shown in FIG. 2, various exemplary embodiments containing the specified quantities of Formulas A-D. were tested for texture with Semolina Durum flour a.s descirbed above. As is shown in FIG, 2, pasta made with Semolina Durum Wheat Flour plus an embodiment containing oat fiber, calcium sulfate and xanthan gum was more firm, more elastic and less sticky than pasta made with pea fiber or pasta made without xanthan gum. Semolina Durum Wheat pastas made with oat fiber, calcium sulfate and xanthan gum were more firm, more elastic and less sticky than the control made with 5% egg white. In the test results over these embodiments, the panel rated semolina durum wheat pasta made with 2.5% of formulation C best overall.

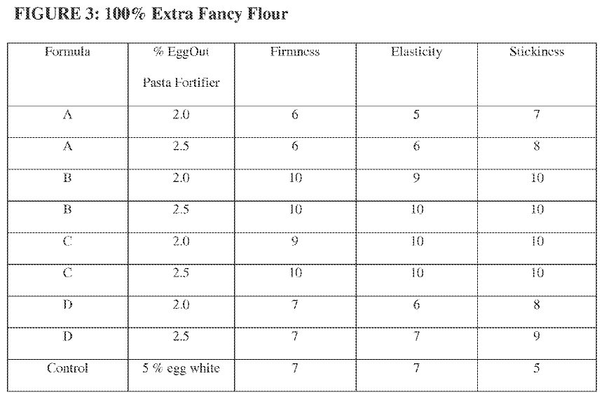

As is shown in FIG. 3, various exemplary embodiments of the fortifier in quantities of Formulas A-D were tested for texture with Extra Fancy Flour. As is shown, pasta containing flour plus embodiments containing oat fiber, calcium sulfate and xanthan gum was more firm, more elastic and less sticky than pasta made with pea fiber or pasta made without xanthan gum. Extra Fancy Wheat pastas made with oat fiber, calcium sulfate and xanthan gum were more firm, more elastic and less sticky than the control made with 5% egg, white. The panel rated the embodiments comprising semolina durum wheat pasta made with 2.5% of Formula B and C best overall.

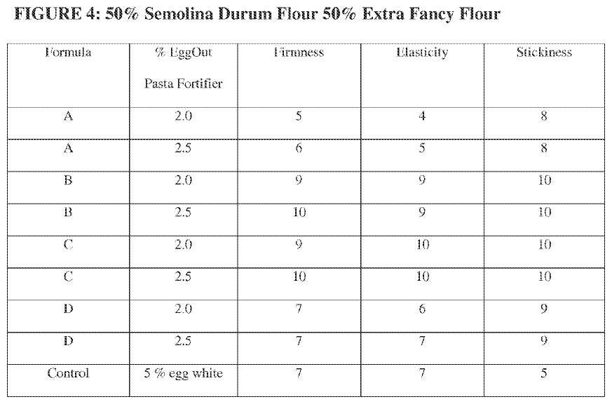

As is shown in FIG. 4, various embodiments of the fortifier in quantities of Formulas A-D were tested for texture with in pasta made with Semolina Durum Wheat Flour and Extra Fancy Flour, The embodiments containing oat fiber, calcium sulfate and xanthan gum were more firm, more elastic and less sticky than pasta made with pea fiber or pasta made without xanthan gum. Semolina Durum Wheat and Extra Fancy Flour pastas made with oat fiber, calcium sulfate and xanthan gum were more firm, more elastic and less sticky than the control made with 5% egg white. The panel rated the embodiment containing semolina durum wheat and extra fancy flour pasta made with 2.5% of Formula C best overall.

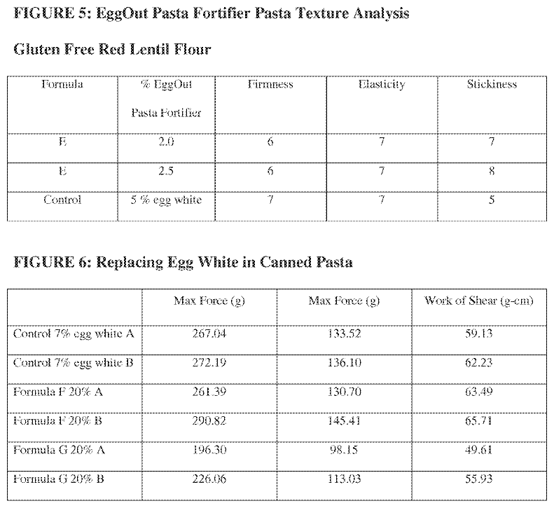

As is shown in FIG. 5 the gluten free embodiment containing Formula E was tested for texture with in pasta made with Red Lentil Flour, and was found to be slightly less firm, more elastic, and less sticky than the control made with 5% egg White.

In FIG. 6, canned pasta was made with 7% egg white as a control and compared with pastas containing the embodiments of Formula F and Formula G. The control included 87.5% semolina, 7% egg white and 5% whole egg. The reduced egg formulas had 74.5% semolina, 5.5% whole egg and 20% of Formula F or Formula G. Pastas were retort canned in Swanson low sodium chicken broth for 15 minutes at 20 psi. Cans were opened after 2 weeks and the texture was measured on a texture analyzer using the blade test apparatus (AACC16-50). Two cans A and B were broached from each test and five pasta strands were tested from each test.

Test averages are seen in FIG. 6. Formula F and the control were not significantly different in firmness while Formula G had about 80% of firmness of the control.

The foregoing description and figures comprise illustrative embodiments of the present invention. The foregoing embodiments and the compositions and methods described herein may vary based on the ability, experience, and preference of those skilled in the art. Merely listing the steps of the method in a certain order does not constitute any limitation on the order of the steps of the method. The foregoing description and figures merely explain and illustrate the invention, and the invention is pot limited thereto. Those skilled in the art who have the disclosure before them will he able to make modifications and variations therein without departing from the scope of the invention.

What is claimed is:

1. A method of making eggless pasta, comprising:
creating an additive, comprising:
at least one salt;
at least one hydrocolloid; and
at least one fiber;
combining the additive with flour and water; and
mixing the additive, flour, and water to create pasta.

2. The method of claim 1, wherein the additive further comprises at least one protein.

3. The method of claim 1, wherein the protein is selected from the group consisting of soy protein, pea protein, or wheat protein.

4. The method of claim 1, wherein the salt is selected from the group consisting of:
organic calcium, inorganic calcium, magnesium, sodium salt, potassium salt, calcium sulfate, calcium phosphate, calcium chloride, calcium carbonate, calcium citrate, calcium lactate, calcium propionate, calcium oleate, magnesium sulfate, magnesium phosphate, magnesium acetate, magnesium chloride, magnesium citrate or magnesium lactate.

5. The method of claim 1, wherein the hydrocolloid is selected from the group consisting of starch, gum, corn starch, pea starch, potato starch, rice starch, wheat starch, pea extract, xanthan, guar, locust bean, gum Arabic, tara gum, algin, carboxymethyl cellulose, carrageenan or pectin, agar, carboxymethyl cellulose, alginate and locust bean gum.

6. The method of claim 1, wherein the fiber is selected from the group comprising: oat fiber, soy fiber, pea fiber, corn fiber, carrot fiber, citrus fiber, potato fiber, rice fiber or orange fiber.

7. A method of making eggless pasta, comprising:
creating an additive, comprising:
at least one salt selected from the group consisting of: organic calcium, inorganic calcium, magnesium, sodium salt, potassium salt, calcium sulfate, calcium phosphate, calcium chloride, calcium carbonate, calcium citrate, calcium lactate, calcium propionate, calcium oleate, magnesium sulfate, magnesium phosphate, magnesium acetate, magnesium chloride, magnesium citrate or magnesium lactate;
at least one hydrocolloid selected from the group consisting of starch, gum, corn starch, pea starch, potato starch, rice starch, wheat starch, pea extract, xanthan, guar, locust bean, gum Arabic, tara gum, algin, carboxymethyl cellulose, carrageenan or pectin, agar, carboxymethyl cellulose, alginate and locust bean gum;
at least one fiber selected from the group consisting of oat fiber, soy fiber, pea fiber, corn fiber, carrot fiber, potato fiber, rice fiber, or orange fiber;
at least one protein selected from the group consisting of soy protein, pea protein, or wheat protein;
combining the additive with flour and water; and
mixing the additive, flour, and water to create pasta;
wherein 1-5% by weight of the pasta comprises the additive.
